(19) United States
(12) Patent Application Publication
(10) Pub. No.: US 2002/0120478 A1
(43) Pub. Date: Aug. 29, 2002

(54) Service management program, method, and apparatus for hotel facilities

(75) Inventor: Norio Tanaka, Sapporo (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/079,844

(22) Filed: Feb. 22, 2002

(30) Foreign Application Priority Data
Feb. 27, 2001 (JP) 2001-053181

(51) Int. Cl. G06F 17/60

(52) U.S. Cl. 705/5

(57) ABSTRACT

The present invention provides a service management program, method, and apparatus for hotel facilities in order to ensure that the present service conditions of the hotel facilities are always obtained at the account places of the hotel facilities so that the most suitable services are offered to the guests of the hotel when the guests visit the hotel facilities. The service management program executes a room-number-input step of obtaining and inputting the room number of a guest when the guest visits the hotel facility; a lodging management system conjunction step of transmitting the room number of the guest to a lodging management system to obtain information about the guest concerned; and a service indication step of comparing a service management table with information about the guest, and of indicating a service suitable for the guest's attributes. The service management method comprises all of the above steps, and the service management apparatus includes the above program.

### BACKGROUND OF THE INVENTION

1. Field of the Invention

The present invention relates to a service management program, method, and apparatus for facilities of a hotel for improving the service to the guests of the hotel in conjunction with a computer of the hotel.

2. Description of the Related Art

In general, a POS (Point of Sales) terminal located in a restaurant, etc. comprises a card reader for the payment by a banking card, a CRT for indicating an amount of money to be paid, a printer for outputting a receipt showing the detail of the account, and so on, and the sales data of the restaurant, etc. is acquired by the computer for the sales management.

The same is true for the POS terminals of hotel facilities such as restaurants, athletic gymnasiums, and theatres. These POS terminals are used for settling the account after the customer has used the facility, and for transmitting the sales data to the host computer for the sales management by the host computer when the receipt is issued at an account place (or check-out counter), but these POS terminals have no function of managing several kinds of services given by the hotel facilities. The hotel has a lodging management system at its front desk, which is used for the guest management from the registration at the check-in to the account at the check-out. The POS terminals of the hotel facilities described above have no connection with the lodging management system of the hotel and have no information about the guests accordingly. Therefore, the POS terminals are not useful for the detailed services which are possible only in the hotel when the guests of the hotel visit the hotel facilities.

Furthermore, in the case in which the facility charge is paid with the hotel charge at the check-out, the room number of the guest must be input at the account place of the facility, in order to inquire about the guest from the lodging management system of the hotel, which requires extra time. In addition, when the guest wants to know the availability of a hotel facility or the seat availability, in the case of a restaurant, the guest has to visit or telephone the restaurant. The same is true for contract facilities near the hotel.

In any case, the POS terminal does not have a system for keeping track of the service availabilities of the facilities clearly, which results in the work efficiency of the account being low and the customer service available from the hotel being insufficient.

In order to solve the above problems, it is proposed that the POS terminal has a seat management function in case of a restaurant, as follows. In the Japanese Unexamined Patent Publication (Kokai) No.5-89370, it is proposed that a guide message is indicated on a POS terminal when there is a vacant seat after a customer inputs his or her name at the account place to reserve a seat, and in the Japanese Unexamined Utility Model Publication (Kokai) No.7-36280, it is proposed that the presence of a vacant seat is automatically announced to the customers by an indicator and/or voice. The above publicly known proposals target a restaurant such as a family restaurant in general, but are not suitable for a hotel restaurant which is a very formal place. In a hotel restaurant, it means a deterioration in the service when a customer must input his or her name, and the announcement by voice is not preferable from a privacy point of view. The seat management as described above in a family restaurant benefits a rapid turnover of customers, but does not contribute to the service appropriate to a hotel.

Furthermore, when a person outside a hotel inquires about a guest of the hotel, it is confirmed by telephone whether or not the guest is in the room after the check-in, and even if the guest is in a restaurant of the hotel, the answer to the inquiry is only that there is no answer from the guest.

In view of the above, facilities such as a restaurant of a hotel should be considered from a viewpoint of offering a service with which customers are satisfied.

In the seat management systems proposed in the above publications, the vacant seats are automatically assigned simply to the customers waiting for them. For a hotel facility, the detailed customer services corresponding to customer attributes such as age, sex, and repeater are required. In the conventional system, when the customer visits a hotel facility, it cannot be determined whether or not the customer is a guest of the hotel, but it is determined at the account by inquiring about the customer from the lodging management system of the hotel, and thereby it take a relatively long time for the account. In addition, since information about the availability of hotel facilities such as a restaurant, athletic gymnasium, and theater is not given to the guests of the hotel, the guests have to inquire about the availabilities by phone or to go to the facilities concerned.

### SUMMARY OF THE INVENTION

It is therefore an object of the present invention to ensure that the present service conditions of hotel facilities are always obtained at the account place (or check-out counter) of the hotel facilities so that the most suitable services are offered to the guests of the hotel when the guests visit the hotel facilities.

In order to achieve the above object, the present invention provides a service management program, method, and apparatus for hotel facilities, wherein the service management apparatus is connected with the host computer of the hotel, and the service management program, method, and apparatus operate in conjunction with the lodging management system including the host computer of the hotel for the management of the guest information from the registration at the check-in to the account at the check-out.

The present invention relates to a service management program, method, and apparatus for hotel facilities, wherein the service management program executes a room number input step of obtaining the room number of a guest which is input by means of the card-key brought with the guest or manually when the guest visits the hotel facility; a lodging management system conjunction step of transmitting the obtained room number to a lodging management system to obtain information about the guest concerned; and a service indication step of comparing a service management table for the management of the attributes of the services of the hotel facilities and for the management of the availabilities of the hotel facilities, with the guest's own attributes in the information about the guest which has been obtained from the lodging management system, and of indicating a service suitable for the guest's attributes such as “VIP”, and “repeater”, the service management method comprises all of the above steps, and the service management apparatus includes said program.

The present invention also relates to a service management program, method, and apparatus for hotel facilities, wherein the service management program executes an account-with-hotel-charge step of transmitting the room number of the guest obtained when the guest visits the hotel facility, in the case in which the facility charge is paid with the hotel charge at the check-out, to the lodging management system with the data of the facility charge to be paid with the hotel charge, in addition to the all of the above steps, the service management method comprises said account-with-hotel-charge step in addition to the all of the above steps, and the service management apparatus includes said program.

The present invention also relates to a service management program, method, and apparatus for hotel facilities, the service management program executes a facility information transmission step of transmitting the service availability information about the hotel facilities to the indicating devices in the guest rooms and the lobby, and to the home page of the hotel, from the service management tables of the hotel facilities, in addition to the all of the above steps, the service management method comprises said facility information transmission step in addition to the all of the above steps, and the service management apparatus includes said program.

The service management apparatus for hotel facilities, the terminals, at the front desk of the hotel and in the guest rooms and the lobby, of the lodging management system of the hotel, and the host computer in the hotel, are connected via a LAN (Local Area Network), so that the required information is transmitted to and received from each other. When the guest visits a facility of the hotel, the attributes of the guest may be obtained by inputting the room number of the guest to the service management apparatus by means of the card-key brought with the guest or manually to inquire about the guest from the lodging management system of the hotel, and the service suitable for the guest may be offered by comparing the attributes of the guest with the service attributes, and thereby the detailed service may be realized.

In the case in which the facility charge is paid with the hotel charge at the check-out, if the service management apparatus has an account-with-hotel-charge means for transmitting the account data with the room number which has been input to the service management apparatus and set in the service management table, the time for the account at the account place of the facility concerned may be reduced. Furthermore, if the service management apparatus has a facility information transmitting means for transmitting the service availability information about the hotel facility, the service availability information may be transmitted to the terminals in the guest rooms and the lobby from the service management table to be indicated on the terminals. This is a very convenient function for the guests.

What is applied to hotels described above is also applied to lodging facilities such as Japanese style hotels, public lodging facilities, etc., and to lodging facilities attached to golf courses, sports facilities, etc. The hotel facilities described above include various facilities such as theatres, athletic gymnasiums, aesthetic saloons, bowling alleys, golf courses, etc. which are used in conjunction with the hotel, and the services offered at the hotel facilities include making available of seats suitable for the attributes of the guests in restaurants, theatres, etc., and making available of training devices, health care program courses, or so, suitable for the attributes of the guests in athletic gymnasiums, aesthetic saloons, or the like.

### BRIEF DESCRIPTION OF THE DRAWINGS

The above object and features of the present invention will be more apparent from the following description of the preferred embodiments with reference to the accompanying drawings, wherein:

FIG. 1 shows a basic system configuration of an embodiment of the present invention;

FIG. 2 shows a principle configuration of the seat management apparatus of a hotel facility of an embodiment of the present invention;

FIG. 3 shows a flow chart of the seat management for hotel facilities;

FIG. 4 shows a seat management table of a restaurant, a facility of a hotel;

FIG. 5 shows a guest management table of a lodging management system of a hotel;

FIG. 6 shows a seat layout of a restaurant, a facility of a hotel;

FIG. 7 shows an example of seat assignment of a hotel facility;

FIG. 8 shows facility code management tables of restaurants;

FIG. 9 shows seat availability information of restaurants; and

FIG. 10 shows a flow chart of settling an account at a hotel facility.

### DESCRIPTION OF THE PREFERRED EMBODIMENTS

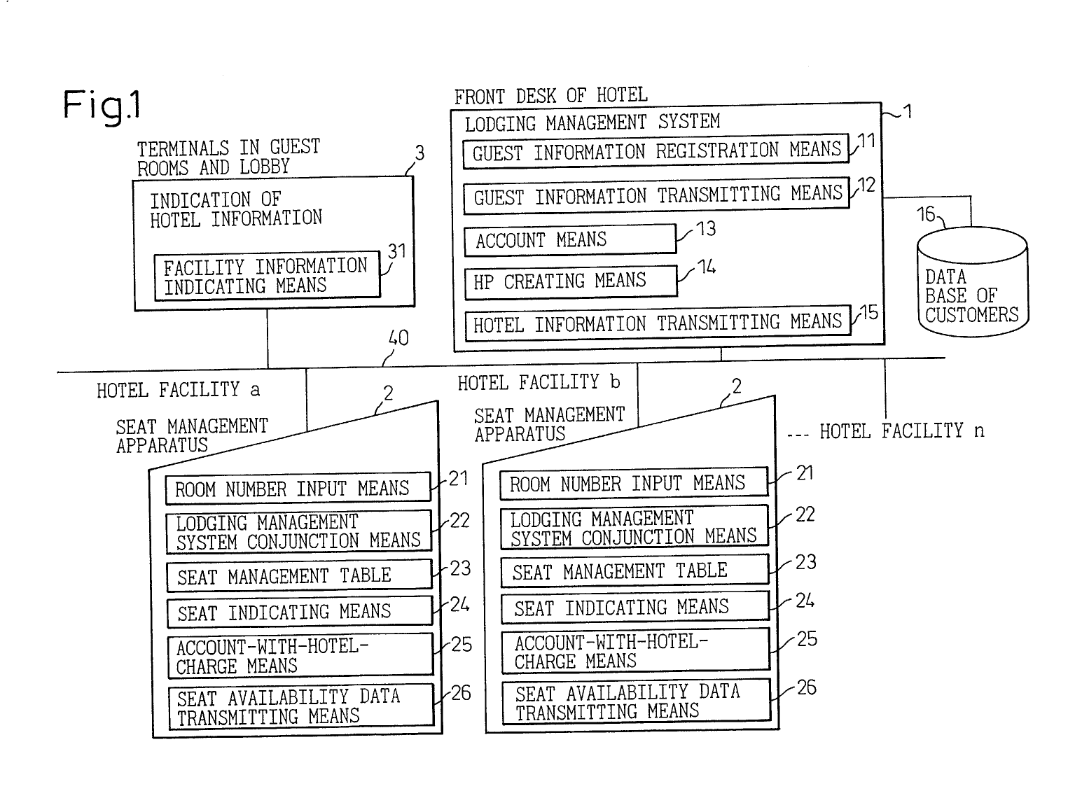

The preferred embodiments of the present invention are described below with reference to FIG. 1 to FIG. 10.

FIG. 1 shows a basic system configuration of an embodiment of the present invention. In this figure, a seat management system is shown as an example of a service management system for hotel facilities. In this system, the lodging management system 1 provided at the front desk of the hotel, the terminals 3 in the guest rooms and the lobby, and the seat management apparatuses 2 of the hotel facilities a, b, . . . , and n are connected to the host computer (not shown) in the hotel and to each other through a LAN, and are capable of transmitting and receiving necessary information.

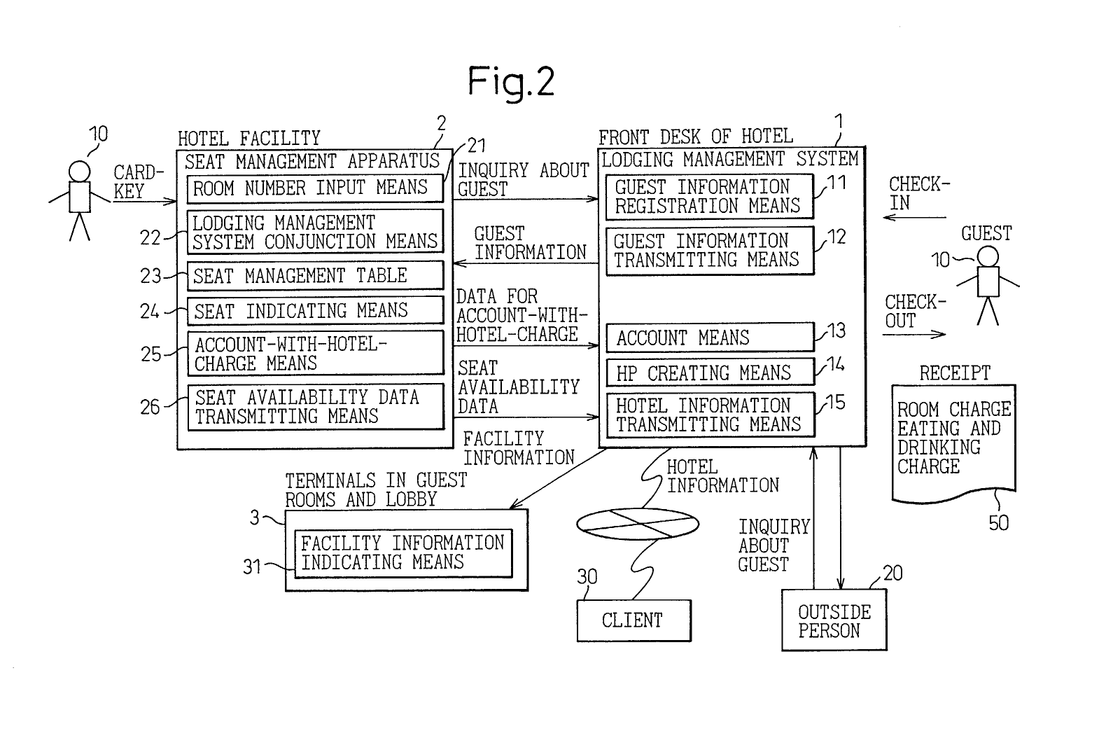

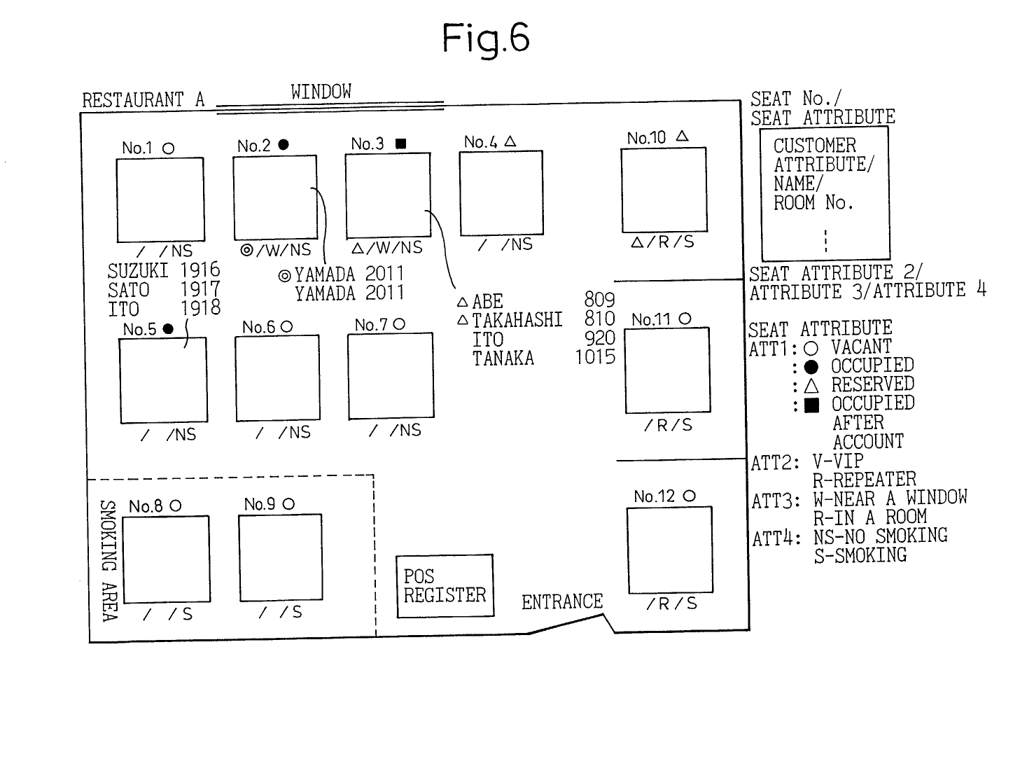

FIG. 2 shows a principle configuration of the seat management apparatus of a hotel facility of an embodiment of the present invention. With reference to FIG. 2, the data flow among the lodging management system 1, the seat management apparatus 2, and the terminals 3 is described below. According to the lodging management system 1 at the front desk, a card-key is handed over to a guest 10 with the registration at the check-in of the guest 10. When the guest 10 visits a facility of the hotel, a person in charge of the account inputs the room number of the guest 10 to the seat management apparatus 2 with the room number input means 21 for obtaining the room number from the card-key brought by the guest 10 or manually. The obtained room number of the guest 10 is transmitted to the lodging management system 1 at the front desk with the lodging management conjunction means 22. The lodging management system 1 which has received the room number transmits the information about the guest corresponding to the room number with the guest information transmitting means 12. In the seat management apparatus 2 of the hotel facility, a seat management table 23 which shows seat attributes such as “seat to be assigned on priority basis” and a present seat availability is set, the seat attributes are compared with the guest's attribute based on the seat information from said seat management table, and the information about the guest 10 which has been obtained from the lodging management system 1, and then the vacant seat to be assigned to the guest 10 is indicated by the seat indicating means 24. It is further effective that the seat management apparatus 2 is equipped with a dedicated indicator to indicate a seat arrangement including seat attributes, and a seat management table, which are legible. It is preferred that the seat arrangement as shown in FIG. 6 is always indicated by the dedicated indicator.

Furthermore, in the case in which it is desired that the charges for the hotel facilities used by the guest are paid in a lump sum with the hotel charge for the guest at the check-out of the guest, the data for the account of the charges for the hotel facilities is transmitted to the lodging management system at the front desk by the account-with-hotel-charge means 25. Furthermore, the seat availability data on the hotel facility is transmitted from the seat management apparatus 2 to the lodging management system 1 at the front desk by the seat availability data transmitting means 26 to renew the HP (home page) data. The renewed seat availability information is indicated on the terminals 3 in the guest rooms and the lobby, and is given on the HP of the hotel, included in the information about the hotel facilities intended for all the customers, and is transmitted to the clients. For the terminals 3 in the guest rooms and lobby, a TV set or an indicating device such as a guide plate mainly for indication is useful.

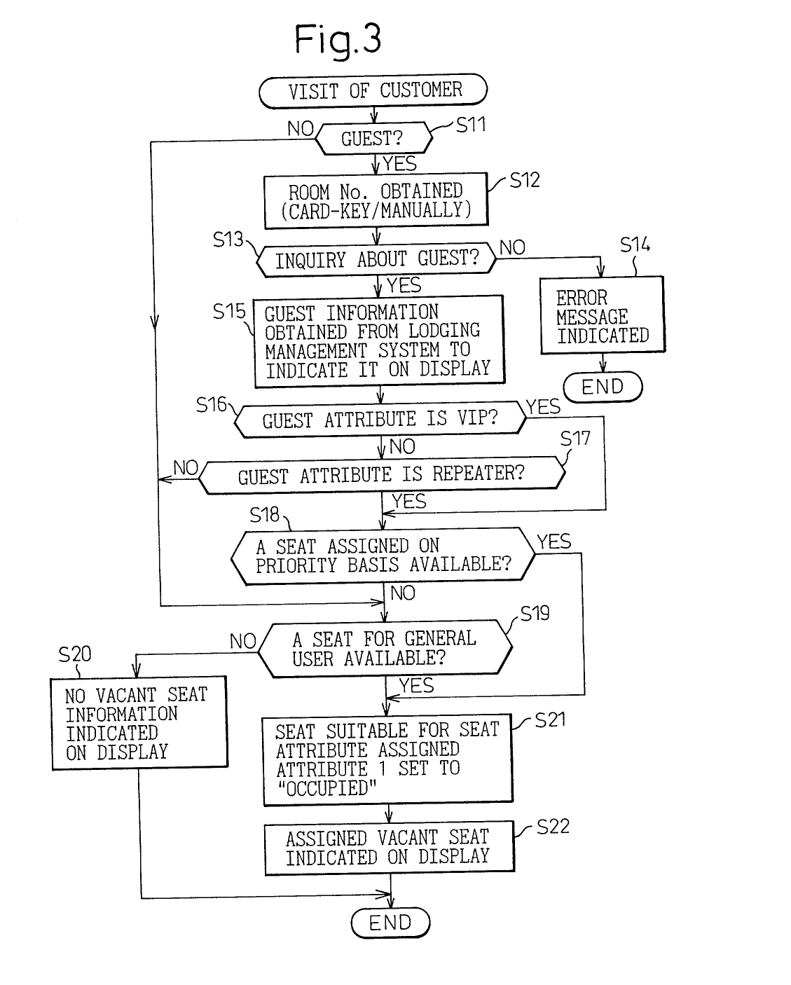

FIG. 3 shows a flow chart of the seat management system for hotel facilities. In the case in which a visitor is a guest 10, a person in charge of the facility receives the card-key of the hotel from the guest 10, and then the room number of the guest 10 is read from the card-key through the card reader (not shown) of the seat management apparatus 2 of the facility, or is input to the seat management apparatus 2 manually (step S12), so that the guest is inquired of the lodging management system 1 of the hotel and thereby the information about the guest such as the room number, name, age, sex, etc. is obtained and indicated on the screen (steps S13 and S15). At the subsequent steps of selecting the seat for the guest according to the guest attributes, it is determined whether the guest is a VIP (important guest), a repeater, or not.

If the guest is a VIP, a seat for a VIP is assigned to the guest on a priority basis. If a seat for a VIP is not available, a seat for a general user is assigned to the guest (steps S16, S18, and S19). Next, the seat attribute 1 of the assigned seat, which designates that the assigned seat is vacant or occupied, is set to “occupied” (step S21). The assigned vacant seat then is indicated on the screen (step S22), and then the guest is taken to the assigned seat. If the guest is a repeater, it is determined that the guest is a repeater (step S17), a seat is assigned to the guest according to the same flow. If the guest is a guest other than a VIP or repeater, a seat is assigned to the guest according to the step S19 and lower steps for selecting a seat for general customers. On the other hand, if the visitor is not a guest of the hotel, a person in charge of the facility performs the seat assignment operation to assign a vacant seat to the visitor automatically, and the seat attribute 1 of the assigned vacant seat is set to “occupied”, and the assigned vacant seat is indicated on the screen, and the visitor is then taken to the assigned seat (steps S19, S21, and S22). When a plurality of guests of the hotel visit the facility, the card-keys of all the guests are handled, and if there is a guest whose attribute is “VIP” or “repeater”, the operation of assigning a seat for a VIP or repeater to the guests is performed.

In the above embodiment, the seat assignment for the guest whose attribute is “VIP” or “repeater” is described as an example. But other attributes such as “with children”, “aged person”, “black listed (a dangerous character, etc.)”, “physically challenged person”, the preferences of guests, etc., may be covered to offer services in more detail, and the above embodiment does not restrict the present invention.

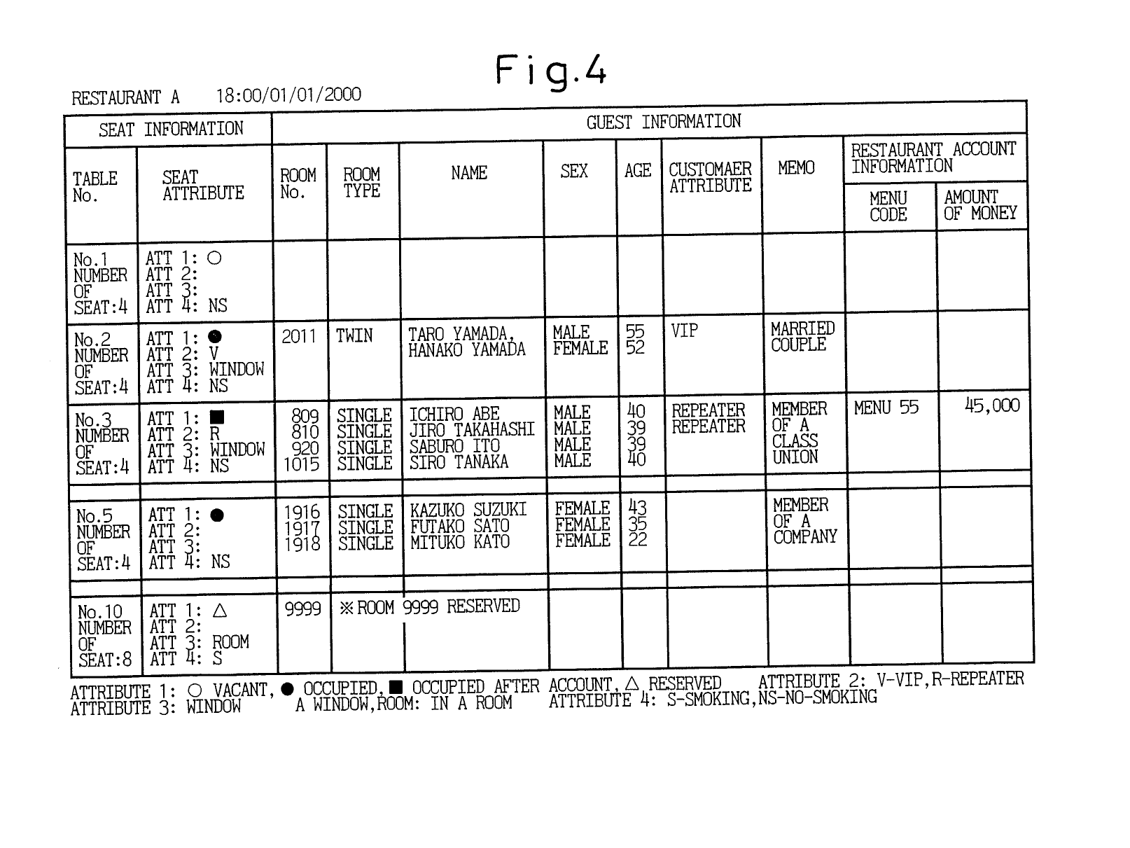

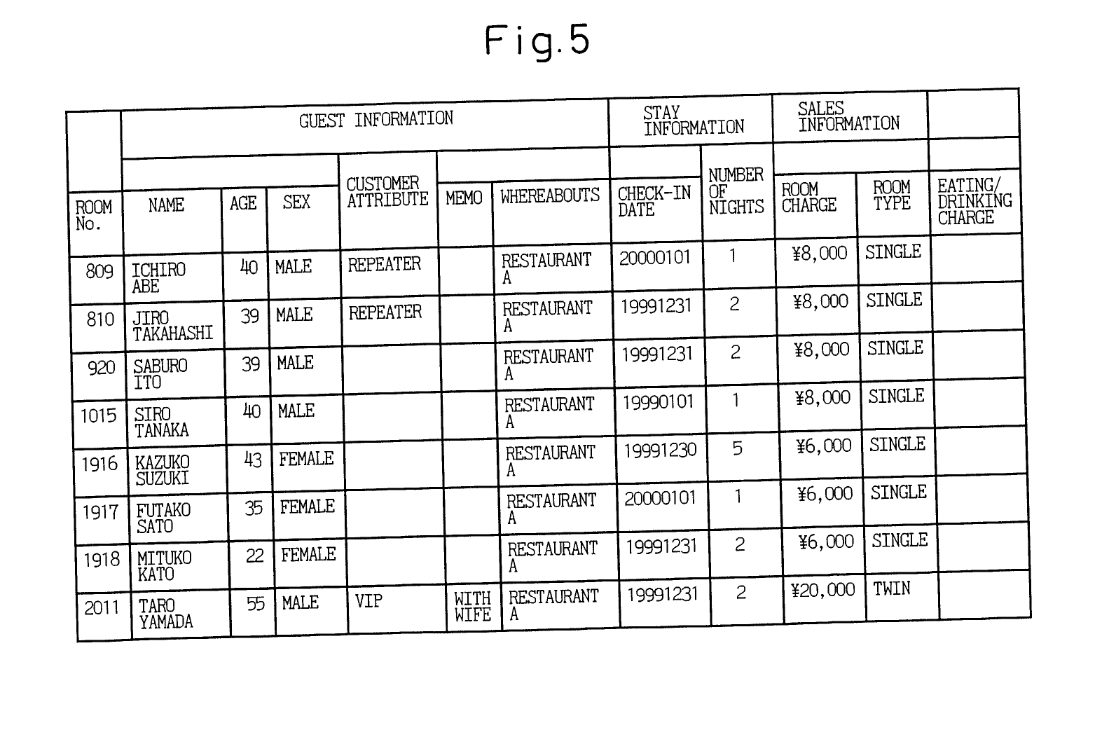

FIG. 4 shows a seat management table in the seat management apparatus 2 of a restaurant, a facility of a hotel facility. FIG. 5 shows a guest management table of the hotel, and FIG. 6 shows a seat layout of a restaurant of the hotel.

The seat management table shown in FIG. 4 consists of a seat information column in which seat attributes are written, and a guest information column in which the information about the guests are written who are now occupying the seats, obtained from the lodging management system of the hotel. The seat attribute 1 is a seat availability, wherein ∘ means that all of the seats are vacant, ● means that at least one of the seats is occupied, Δ means that at least one of the seats is reserved, and ▪ means “occupied after account” which is in the state that the account has been settled after the meal but at least one of the seats is still occupied. The seat attribute 2 is the seat priority information about whether the seats are assigned to VIPs or repeaters on a priority basis, wherein V means that the seats are assigned to VIPs (important guests), and R means that the seats are assigned to repeaters. The seat attribute 3 is the table position information about whether the table is located near a window, in a room, or not, and the seat attribute 4 is the smoking availability information about whether the seats are smoking seats or non-smoking seats.

For example, it is understood from the seat information about No.3 table that number of the seats is 4, the table is located near a window, the seats are no-smoking seats, the seats are occupied by the guests who are members of a class reunion, two of which are repeaters. In addition, it is understood from the guest information of No.3 table that the present state of No.3 table is that the person of room number 809 has settled the account after the meal but the other persons are at meal and the seats are still occupied.

Although a seat management table of a restaurant is shown, the similar expression may be adopted for the seat management of other hotel facilities

For example, in the case of a theatre, it can be designated with a seat attribute of a seat that the seat is a seat to be assigned to a VIP, a repeater, or the like, on a priority bases, a seat near the entrance to be assigned to a physically challenged person, or a front seat to be assigned to a child. In the case of an athletic gymnasium, training facilities or health care program courses may be adopted instead of seats. In the health care program course, a health care program suitable for the attributes such as age, sex, etc., of a guest is assigned to the guest.

In the guest management table shown in FIG. 5, a room number, guest information such as name, age, sex, customer's attributes (VIP, repeater, etc.), memo, and whereabouts (restaurant, other hotel facilities, etc.), stay information such as check-in date and number of nights of the stay, sales information such as room charge and room type, and other information such as charge for eating and drinking are written for each guest. In addition, preferences, addresses, company names, job titles, etc., which are not included in the above items are written as useful information in this table.

In the seat layout of a restaurant shown in FIG. 6, seat attributes such as seat availability (vacant or occupied), guest names, and room numbers are indicated in the form of the actual layout in such a manner that a person in charge of the account understands the layout at a glance. By indicating names and room numbers of the guests like that, a rapid reaction to an urgent inquiry from an outside person may be possible. The marks ∘, ●, Δ, and ▪ in the figure mean “vacant”, “occupied”, “reserved” and “occupied after account” respectively, and the codes V and R in the figure mean “VIP” and “repeater” respectively, as in FIG. 4.

Seat layouts of other hotel facilities such as a theatre and athletic gymnasium, similar to this layout, may be indicated on the displays of the seat management apparatuses of these facilities. In the case of a theatre, since it has many seats, it is preferred that for example a layout only showing the seats to be assigned on a priority bases and special seats, and seat attributes such as “VIP”, “repeater”, and “physically challenged person” are indicated in a simplified form. Further, in the case of an athletic gymnasium, an indication with emphasis on a layout of training facilities and attributes such as age and sex would be considered.

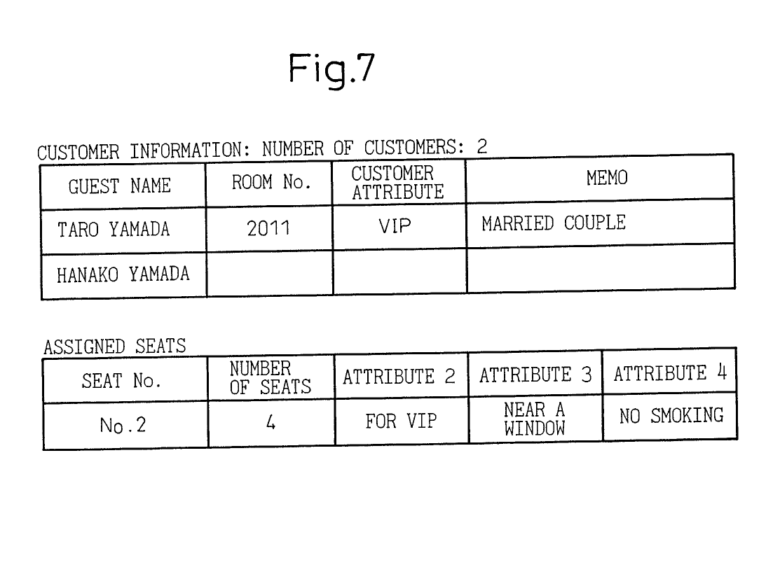

FIG. 7 shows an example of seat assignment of a restaurant, a facility of a hotel, corresponding to the customer attributes of the guests of the hotel. In the customer information table, guest names, room numbers, customer attributes, and memos obtained from the lodging management system are indicated and, in the seat assignment table, Nos. of seats to be assigned, seat attributes 2 such as “VIP” and “repeater”, seat attributes 3 such as “near a window” and “in a room”, and seat attributes 4 such as “no-smoking” and “smoking” are indicated. In this example, the guests which have visited to the restaurant are Mr. Taro Yamada and Mrs. Hanako Yamada, a married couple, who are important customers staying in room 2011. To these guests having such customer attributes, no-smoking seats near a window for VIPs are assigned.

Expressions similar to the tables shown in FIG. 7 may be applied to the other hotel facilities for which the seat assignment table is replaced with a table in which attributes peculiar to the facilities are written.

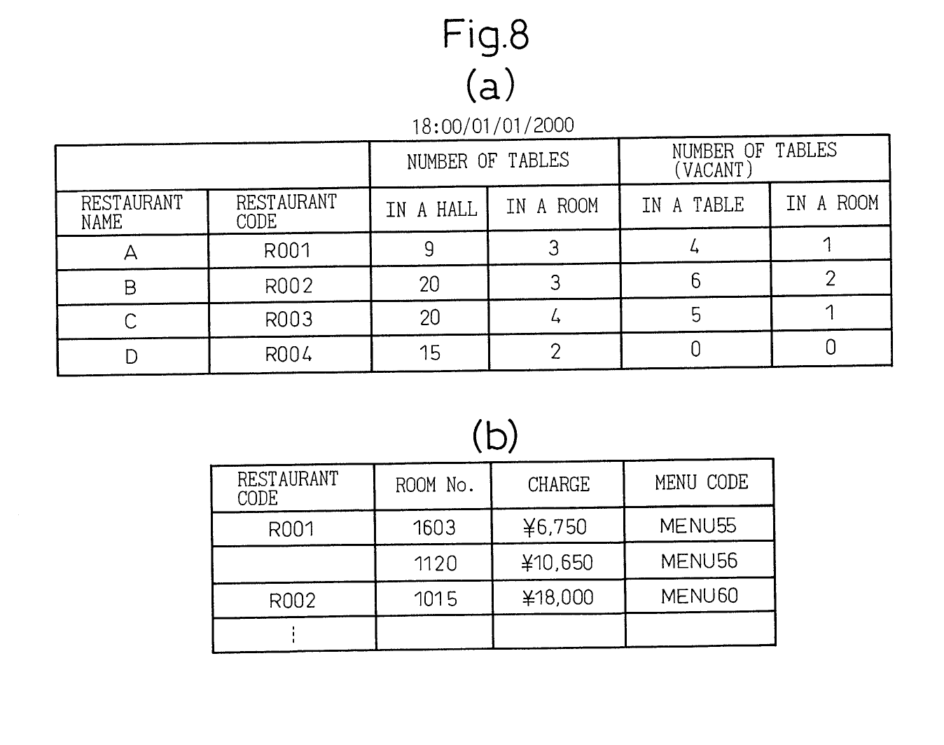

FIG. 8 shows the management tables by which the restaurants of a hotel are managed by restaurant code. In this case, portion (a) of FIG. 8 is a vacant seat table in which vacant seats are listed by restaurant code; and portion (b) of FIG. 8 is an account-with-hotel-charge table in which the restaurant charges to be paid with the hotel charges are listed by restaurant code.

In the vacant-seat table, restaurant names, restaurant codes, numbers of tables, and numbers of tables with vacant seats are written, and in the account-with-hotel-charge table, restaurant codes, room numbers, accounts, and menu codes are written. This figure shows the management tables for the restaurants, which may be adopted for other hotel facilities by replacing the restaurant codes with the hotel facility codes.

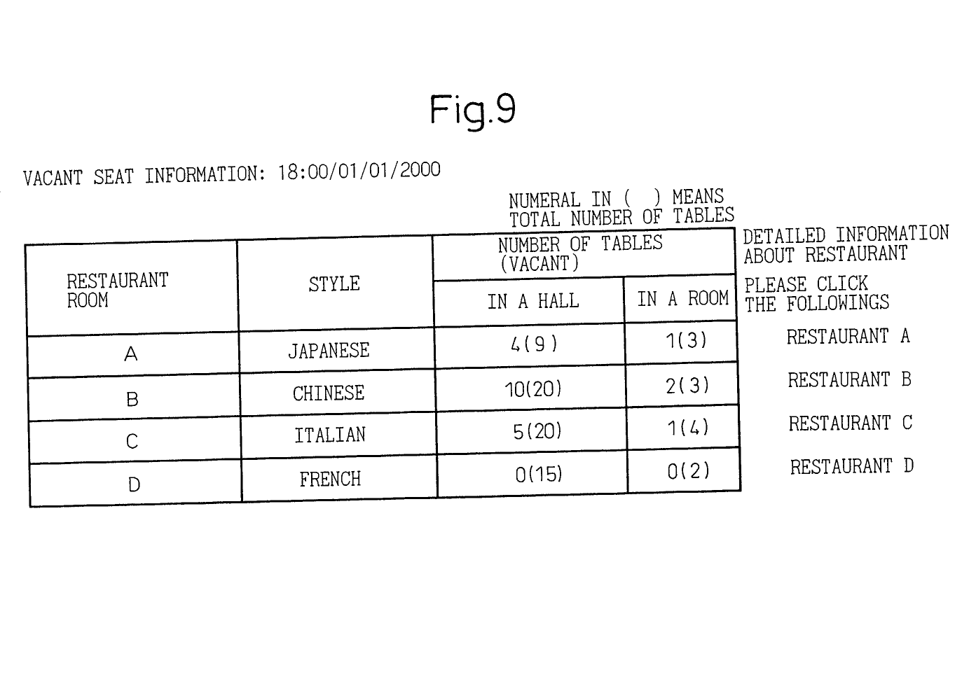

FIG. 9 shows an example of seat availability information to be indicated on the terminals in the guest rooms and lobby and on the home page of the hotel. By using this information, a timely reservation via the Internet at the location distant from the restaurants may be realized. This figure shows the seat availability information of restaurants, but similar expression may be adopted for other hotel facilities.

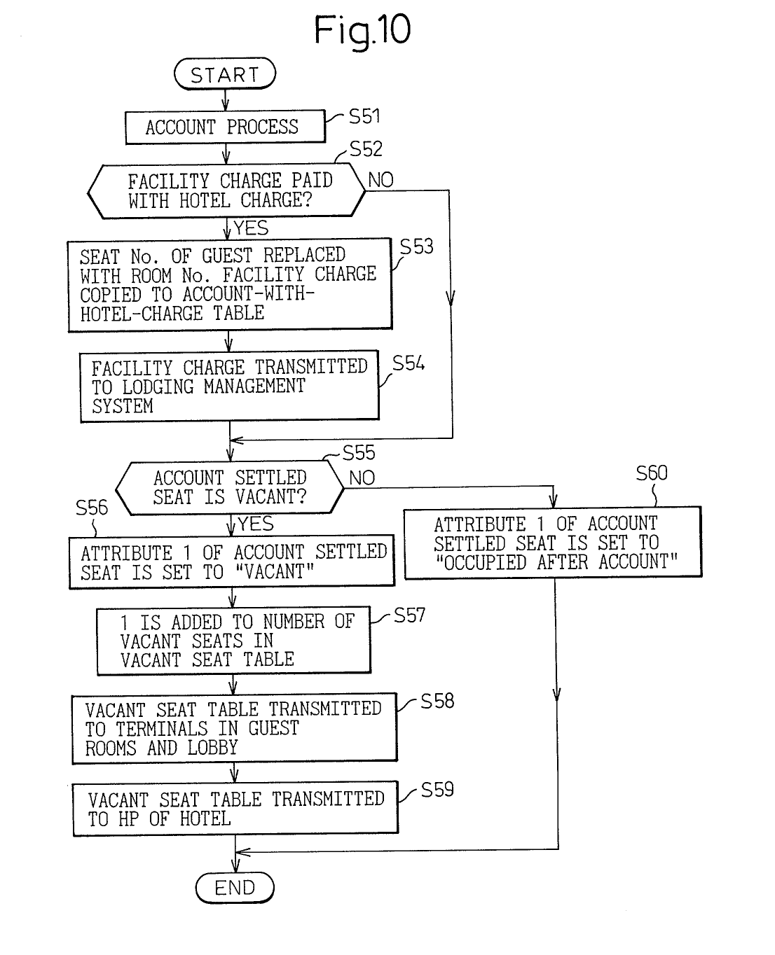

FIG. 10 shows a flow chart of settling an account at a hotel facility. At first, the charge for the facility used by a guest 10 is registered (step S51). Next, it is determined whether the facility charge is paid in cash or will be paid with the hotel charge at the check-out (step S52). If the facility charge will be paid with the hotel charge at the check-out, the seat number for the guest 10 is replaced with the room number of the guest which was set when the guest visited to the facility and the facility charge in the seat management table is copied to the account-with-hotel-charge table (step S53). Then the data of the facility charge to be paid with the hotel charge is transmitted to the lodging management system 1 at the front desk of the hotel (step S54).

When the seat to which the account has been settled is vacant, the seat attribute 1 of the seat is set to “vacant” (steps S55 and S56), and 1 is added to the number of vacant seats in the vacant-seat table (step S57), and then the seat-availability data is transmitted to the terminals 3 in the guest rooms and lobby (step S58). At the same time, the seat-availability information of the home page of the hotel is renewed (step S59). If the seat to which the account has been settled is still occupied, the seat attribute 1 of the seat is set to “occupied after account” (step S60).

Seat management systems for restaurants, etc., are described above as examples of services offered by hotel facilities, but the present invention is not limited to them. Services of offering seats and equipment suitable for the attributes of guests such as age, sex, taste, etc., may be available at the facilities such as bars, lounges, theatres, amusement facilities, bowling alleys, athletic gymnasiums, etc. In particular, the services of offering a series of program courses including health care program courses, cosmetic program courses, etc., suitable for the attributes of guests such as age, sex, occupations, positions, etc., may be achieved at an athletic gymnasiums, aesthetic saloons, etc.

Included in the hotel facilities described above are various facilities such as a restaurant attached to, and contact facilities near, lodging facilities such as hotels, Japanese style hotels, tourist homes, public lodging facilities, etc., and facilities, having lodging facilities, such as golf courses, sports facilities, amusement parks, etc.

In the preferred embodiments of a service management apparatus for a hotel facility, such as a seat management apparatus, according to the present invention, described above, services of the facility suitable for the customer attribute of the guest of the hotel may be selected by reading the card-key of the guest and obtaining the information about the guest, and thereby the detailed services which are possible only in a hotel, different from services of a facility other than a hotel, may be realized. When a customer is a VIP or repeater, the seat always used by the customer may be assigned to the customer, and thereby high quality services may be offered by any one of the persons in charge of the hotel facility. Furthermore, when the memos in the guest information are put to practical use for customers with children, customers with a bad leg, etc, for example, in a restaurant, the customers may be given consideration such as that the seats near which there are vacant seats, or the seats near the entrance are assigned to the customers.

Furthermore, when an outside person inquires about a guest of the hotel, an accurate answer about the whereabouts of the guest can be given to the person by checking the service management table such as a seat management table, and thereby a rapid reaction to a urgent inquiry may be available.

And when the seat availability information is transmitted to the terminals in the guest rooms and lobby, the guests may select the empty hotel facilities to visit, or may go to the preferable facilities during less busy hours. Furthermore, since a restaurant of a hotel is often located on the upper floor of the building, the guests in the lobby may also have information about the seat availability of the hotel without going to the restaurant, which results in a very useful service. By indicating the seat availability information about hotel facilities on the home page of the hotel, the information may be offered to those outside of the hotel realistically, thus increasing the repeaters of the hotel. Furthermore, in the case in which the facility charge is paid with the hotel charge at the check-out, since the necessary data about the guest is obtained from the lodging management system when the guest visits the facility, the time for settling the account at the account place of the facility may be reduced.

1. A service management program for hotel facilities, which operates in conjunction with a lodging management system for the management of information about the guests of the hotel from the registration at the check-in to the account at the check-out, the program executing:
a room number input step of obtaining and inputting the room number of a guest when the guest visits the hotel facility;
a lodging management system conjunction step of transmitting the room number of the guest to a lodging management system to obtain the information about the guest concerned; and
a service indication step of comparing a service management table for the management of the attributes of the services of the hotel facilities and for the management of the availabilities of the hotel facilities, with the guest's own attributes in the information about the guest which has been obtained from the lodging management system, and of indicating a service suitable for the guest's attributes.

2. The service management program for hotel facilities as set forth in claim 1 further executing an account-with-hotel-charge step of transmitting the room number of the guest obtained when the guest visits the hotel facility, in the case in which the facility charge is paid with the hotel charge at the check-out, to the lodging management system with the data of the facility charge to be paid with the hotel charge.

3. The service management program for hotel facilities as set forth in claim 1 further executing a facility information transmission step of transmitting the service availability information about the hotel facility to the indicating devices in the guest rooms and the lobby, and to the home page of the hotel, from the service management table of the hotel facility.

4. A service management method, for hotel facilities, which operates in conjunction with a lodging management system for the management of information about the guests of the hotel from the registration at the check-in to the account at the check-out, the method comprising:
a room-number-input step of obtaining and inputting the room number of a guest when the guest visits the hotel facility;
a lodging management system conjunction step of transmitting the room number of the guest to a lodging management system to obtain the information about the guest concerned; and
a service indication step of comparing a service management table for the management of the attributes of the services of the hotel facilities and for the management of the availabilities of the hotel facilities, with the guest's own attributes in the information about the guest which has been obtained from the lodging management system, and of indicating a service suitable for the guest's attributes.

5. The service management method for hotel facilities as set forth in claim 4 further comprising an account-with-hotel-charge step of transmitting the room number of the guest obtained when the guest visits the hotel facility, in the case in which the facility charge is paid with the hotel charge at the check-out, to the lodging management system with the data of the facility charge to be paid with the hotel charge.

6. The service management method for hotel facilities as set forth in claim 4 further comprising a facility information transmission step of transmitting the service availability information about the hotel facility to the indicating devices in the guest rooms and the lobby, and to the home page of the hotel, from the service management table of the hotel facility.

7. A service management apparatus for hotel facilities, which operates in conjunction with a lodging management system for the management of information about the guests of the hotel from the registration at the check-in to the account at the check-out, the apparatus comprising:
a room-number-input means for obtaining and inputting the room number of a guest when the guest visits the hotel facility;
a lodging management system conjunction means for transmitting the room number of the guest to a lodging management system to obtain the information about the guest concerned; and
a service indication means for comparing a service management table for the management of the attributes of the services of the hotel facilities and for the management of the availabilities of the hotel facilities, with the guest's own attributes in the information about the guest which has been obtained from the lodging management system, and for indicating a service suitable for the guest's attributes.

8. A computer readable recording medium for recording a service management program for hotel facilities, which operates in conjunction with a lodging management system for the management of information about the guests of the hotel from the registration at the check-in to the account at the check-out, the program executing:
a room-number-input step of obtaining and inputting the room number of a guest when the guest visits the hotel facility;
a lodging management system conjunction step of transmitting the room number of the guest to a lodging management system to obtain the information about the guest concerned; and
a service indication step of comparing a service management table for the management of the attributes of the services of the hotel facilities and for the management of the availabilities of the hotel facilities, with the guest's own attributes in the information about the guest which has been obtained from the lodging management system, and of indicating a service suitable for the guest's attributes.
